(19) United States
(12) Patent Application Publication
(10) Pub. No.: US 2025/0187042 A1
(43) Pub. Date: Jun. 12, 2025

(54) CLEANING DEVICE FOR A BAR-SHAPED STRUCTURE AND CLEANING METHOD FOR REMOVING IMPURITIES

(71) Applicant: TRUMPF Schweiz AG, Grüsch (CH)

(72) Inventors: Andreas Neuweiler, Chur (CH); Andreas Janutin, Chur (CH)

(21) Appl. No.: 19/054,941

(22) Filed: Feb. 17, 2025

Related U.S. Application Data
(63) Continuation of application No. PCT/EP2023/069672, filed on Jul. 14, 2023.

(30) Foreign Application Priority Data
Aug. 19, 2022 (DE) 10 2022 120 966.0

(51) Int. Cl. B08B 1/36; B08B 1/16; B24B 7/00

(52) U.S. Cl. CPC B08B 1/36; B08B 1/165; B24B 7/00

(57) ABSTRACT

A cleaning device for removing impurities from a bar-shaped structure includes a drive unit, and two roughing discs capable of being driven to rotate about a common axis of rotation. At least one roughing disc of the two roughing discs is capable of being driven by the drive unit. The two roughing discs form, along the common axis of rotation, a receiving region for the bar-shaped structure. Each roughing disc has, on a side facing the receiving region, a plurality of roughing projections. The two roughing discs are formed along the axis of rotation in a movably sprung manner in order to cause, in a state in which the two roughing discs are arranged on the bar-shaped structure, the roughing discs to be pushed onto both sides of the bar-shaped structure.

### CROSS REFERENCE TO RELATED APPLICATIONS

This application is a continuation of International Application No. PCT/EP2023/069672 (WO 2024/037804 A1), filed on Jul. 14, 2023, and claims benefit to German Patent Application No. DE 10 2022 120 966.0, filed on Aug. 19, 2022. The aforementioned applications are hereby incorporated by reference herein.

### FIELD

Embodiments of the invention relate to a cleaning device for removing impurities from a bar-shaped structure and to a cleaning method.

### BACKGROUND

Such cleaning devices and cleaning methods are used, for example, for cleaning production pallets that are used to support panel blanks during the laser production of workpieces. The panel blanks are positioned on bar-shaped support bars of the production pallet and moved together with the production pallet into the processing region of the laser processing machine. During the laser processing of the panel blanks, slag is produced by the melting of the panel blanks, which slag adheres to the support bars. If the adhering slag is not removed, the support bar and/or the entire production pallet must be replaced, as otherwise proper positioning of the panel blanks is no longer possible.

Cleaning devices are typically used to clean the support bars. These cleaning devices are arranged on a support bar to be cleaned and use lifting tools to scrape off the slag adhering to the support bar. However, for structural reasons, the slag can only be scraped off to a minimum slag thickness, thus preventing complete removal of the impurities.

As laser power continues to increase during workpiece production, slag adheres more strongly to the support bars, which slag can only be inadequately removed using conventional cleaning devices.

### SUMMARY

Embodiments of the present invention provide a cleaning device for removing impurities from a bar-shaped structure. The cleaning device includes a drive unit, and two roughing discs capable of being driven to rotate about a common axis of rotation. At least one roughing disc of the two roughing discs is capable of being driven by the drive unit. The two roughing discs form, along the common axis of rotation, a receiving region for the bar-shaped structure. Each roughing disc has, on a side facing the receiving region, a plurality of roughing projections. The two roughing discs are formed along the axis of rotation in a movably sprung manner in order to cause, in a state in which the two roughing discs are arranged on the bar-shaped structure, the roughing discs to be pushed onto both sides of the bar-shaped structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a first embodiment of the cleaning device in a state arranged on a bar-shaped structure;

FIG. 2 shows the embodiment of the cleaning device according to FIG. 1 with protective covers;

FIG. 3 shows the cleaning device from FIG. 2 in a perspective view of its underside;

FIG. 4 shows the cleaning device according to FIGS. 1 to 3 with a bar guide in a perspective view on its underside;

FIG. 5 shows the cleaning device from FIG. 4 in a side view;

FIG. 6 shows the cleaning device from FIGS. 4 and 5 with a first embodiment of a roughing disc in a sectional view;

FIG. 7 shows a second embodiment of a roughing disc in a perspective view; and

FIG. 8 shows a cleaning method according to embodiments of the invention in a schematic flow chart.

### DETAILED DESCRIPTION

Embodiments of the invention can carry out the cleaning of bar-shaped structures quickly and easily and to increase the cleaning quality.

A cleaning device is provided according to embodiments of the invention. The cleaning device is suitable for removing impurities from a bar-shaped structure. The term ‘bar-shaped structure’ is defined here as an elongated object which can be moved by the cleaning device along the longitudinal axis. The cleaning device is particularly suitable for removing slag from a support bar of a pallet for workpieces to be produced in a laser cutting machine. The cleaning device has at least one drive unit and two roughing discs which can be driven to rotate about a common axis of rotation. The term ‘roughing disc’ is defined here as a disc which is suitable for removing impurities by means of a rotational movement. Of the two roughing discs, at least one, preferably each, roughing disc can be driven by the drive unit. The roughing discs are arranged at a distance from one another along the common axis of rotation. The roughing discs form a receiving region for the bar-shaped structure. In other words, the receiving region for the bar-shaped structure is formed between the roughing discs. Each roughing disc has, on a side facing the receiving region, a plurality of roughing projections. The roughing discs are formed along the axis of rotation in a movably sprung manner in order to cause, in a state in which they are arranged on the bar-shaped structure, the roughing discs to be pushed onto both sides of the bar-shaped structure.

In other words, a cleaning device is proposed which provides for the removal of impurities from a bar-shaped structure by applying two rotatingly driven roughing discs to the two sides of the bar-shaped structure to be cleaned. The roughing discs are arranged on the cleaning device so that they can move in a transverse direction to the bar-shaped structure in order to ensure that the roughing discs can be adjusted while the impurity is continuously removed. In this way, complete removal of even the most stubborn impurities can be ensured. A further advantage is that the cleaning device can be adapted to different bar widths of the bar-shaped structures to be cleaned.

Roughing discs are provided according to embodiments of the invention. The removal of impurities is preferably carried out via one side surface of each roughing disc. In other words, the roughing disc can be moved in the axial direction, or along its axis of rotation, into contact with the impurity, while the peripheral side of the roughing disc preferably has no cleaning function. The roughing discs can be designed for grinding and/or impacting material removal. Preferably, the roughing discs engage the impurity both in a grinding and impacting manner, which can achieve a high removal rate of the impurities.

The roughing discs are arranged on the cleaning device so that they can move along the axis of rotation. In other words, the roughing discs are movable transversely to the bar-shaped structure to be cleaned. This allows the roughing discs to be moved or displaced to the side for easier arrangement of the cleaning device on the bar-shaped structure. According to embodiments of the invention, the roughing discs are also arranged in a sprung manner. For example, technical springs, preferably compression springs, preferably spiral springs, can be used for the spring arrangement. This enables the roughing discs to be pressed reliably against the bar-shaped structure.

During operation of the cleaning device, the roughing discs preferably have a speed of between 1000 and 6000 revolutions per minute, preferably between 2000 and 5000 revolutions per minute. This allows effective abrasion of the impurity without causing an unnecessarily high degree of wear to the roughing discs.

In a preferred embodiment of the cleaning device, the roughing discs are arranged parallel to each other. This enables a compact and structurally simple design of the cleaning device, which can reduce manufacturing costs.

Further preferred is an embodiment of the cleaning device in which the roughing discs form a tapering receiving region section in a radially inward direction. In other words, the receiving region becomes narrower with the increasing penetration depth of the bar-shaped structure. This allows for a continuously increasing abrasion of impurity, which can reduce the noise generated during cleaning of the bar-shaped structure. Preferably, the receiving region on the radially outer side of the roughing discs is wider than a width of the bar-shaped structure to be cleaned. In other words, the receiving region can have an entry angle. This makes it easier to place the cleaning device on the bar-shaped structure.

In a preferred further development of the cleaning device, it is provided that the roughing discs form a widening receiving region section adjoining the tapering receiving region section in a radially inward direction. This allows the maximum abrasion by the cleaning device to be limited to a roughing width. In this case, the roughing width represents the smallest distance between the roughing discs. Once the bar-shaped structure has reached the roughing width, no further material removal is carried out. This can reliably prevent unnecessary material removal.

An embodiment of the cleaning device, in which the roughing projections are designed as a surface grain formed on the roughing disc, is preferred. This allows the roughing discs to be manufactured particularly quickly and inexpensively, which can reduce the manufacturing costs and operating costs of the cleaning device. The surface grain preferably has increased hardness and toughness. Preferably, the surface grain is formed by applying segments of corundum, silicon carbide, cubic boron nitride and/or synthetic diamond to the surface of the roughing disc. This can extend the service life of the roughing discs.

An embodiment of the cleaning device, in which the roughing projections are designed as blade rails arranged on the roughing disc, is preferred. The blade rails can be detachably attached to a roughing disc base body. This allows individual roughing projections to be replaced while reusing the remaining roughing disc, thus keeping repair costs low.

In a preferred embodiment of the cleaning device, it has a structural stop for limiting a penetration depth in a penetration direction of the roughing discs into the bar-shaped structure. In this way, misuse due to the cleaning device penetrating too deeply can be reliably prevented. The structural stop can be designed to rest on a bar-shaped structure. Preferably, the structural stop is designed to rest on a plurality of bar-shaped structures. This can be possible, for example, with support bars of a pallet arranged in parallel. This also allows the structural stop to prevent the cleaning device from tipping over during operation.

Preferably, the structural stop is designed to be adjustable, in particular continuously, by adjusting the receptacle of the roughing discs. In other words, the structural stop can be designed to adapt the penetration depth to the bar-shaped structure. This allows the cleaning device to be used even more flexibly for a variety of different bar-shaped structures.

Furthermore, an embodiment of the cleaning device is preferred in which the roughing discs are driven by at least one belt drive. A belt drive is a particularly reliable type of power transmission and has low manufacturing and maintenance costs.

Further preferred is an embodiment of the cleaning device, in which the roughing discs are each arranged on a drive shaft. This allows the roughing discs to be decoupled from one another, meaning that the roughing discs can be operated at different speeds and/or directions of rotation if required. This allows the cleaning device to be adapted even more flexibly to the bar-shaped structures to be cleaned and/or impurities to be removed.

In a preferred embodiment of the cleaning device, the roughing discs have contrary directions of rotation. This allows the torques of the roughing discs to cancel each other out, which improves the handling of the cleaning device. Contrary speeds can be achieved, for example, by using a plurality of belt drives and/or a transmission.

In a preferred development, the cleaning device has two drive units, wherein the roughing discs are each driven by one of the drive units. This can increase the performance of the cleaning device if needed. This can be the case, for example, when bar-shaped structures requiring a larger diameter of the roughing discs are to be cleaned.

An embodiment of the cleaning device is preferred in which it has a spreading mechanism, wherein the spreading mechanism is designed to widen the receiving region. A spreading mechanism can simplify the arrangement on the bar-shaped structure and/or the removal from the bar-shaped structure by temporarily increasing the distance between the roughing discs.

In a preferred development of the cleaning device, the spreading mechanism is designed as a lever system. A lever system allows the receiving region to be widened manually using levers. This is a particularly cost-effective and robust method.

Furthermore, an embodiment of the cleaning device is preferred, having a bar guide, wherein the bar guide causes the cleaning device to be guided parallel to the roughing discs in a feed direction of the cleaning device. This can prevent misuse by twisting the cleaning device relative to the bar-shaped structure.

In a preferred development of the cleaning device, the bar guide has four guide rollers, wherein the guide rollers can be arranged at right angles to the feed direction and the axis of rotation. Two of the four guide rollers can be arranged upstream of the roughing discs in the feed direction and two of the four guide rollers can be arranged downstream of the roughing discs in the feed direction. This allows the cleaning device to be guided and at the same time prevents the roughing discs from coming into contact with obstacles along the bar-shaped structure—for example, a pallet edge framing a plurality of support bars.

Preferably, the guide rollers are rotatably arranged on the cleaning device or have a rotatable peripheral region adjacent to the bar-shaped structure. This allows the bar to be guided with particularly low friction.

Further preferably, the guide rollers can have a rubberized surface. The rubberized surface is preferably in contact with the bar-shaped structure during operation of the cleaning device. This can reduce the generation of vibrations and noise.

A further development of the cleaning device, in which the guide rollers protrude beyond the roughing discs in a penetration direction, is preferred. In other words, the guide rollers form a protective stop in the penetration direction. This prevents unintentional contact between the peripheral sides of the roughing discs.

Furthermore, a further development of the cleaning device is preferred in which the cleaning device has two guide plates arranged in parallel, wherein an upstream guide roller and a downstream guide roller are each connected by means of a guide plate. The guide plates are preferably arranged at the far end of the guide rollers. This allows the bar guide to be made particularly robust. Furthermore, a protective stop can be designed to be particularly secure in the penetration direction.

Embodiments of the invention also provide a cleaning method. The cleaning method is suitable for removing impurities from a bar-shaped structure. In particular, the cleaning method is suitable for removing slag from a support bar of a pallet for workpieces to be produced in a laser cutting machine. According to embodiments of the invention, the cleaning device described above and below is provided for removing the impurities. The cleaning method comprises the following steps:
a) arranging the bar-shaped structure between the roughing discs;
b) moving the cleaning device along the bar-shaped structure.

Moving the cleaning device means moving the cleaning device forwards and/or backwards along the bar-shaped structure. Preferably, the direction of rotation is adjusted when the direction of movement is changed. In rare cases, it can be provided that the cleaning device is lifted, rotated and repositioned on the same bar-shaped structure.

The method steps can be carried out several times, in particular many times. This allows for the removal of impurities to be carried out particularly effectively. Preferably, another bar-shaped structure to be cleaned is provided before the method steps are carried out again.

According to embodiments of the invention, the features mentioned above and those yet to be explained further may be used in each case individually or together in any desired expedient combinations. The embodiments shown and described should not be understood as an exhaustive list, but rather are of an exemplary character.

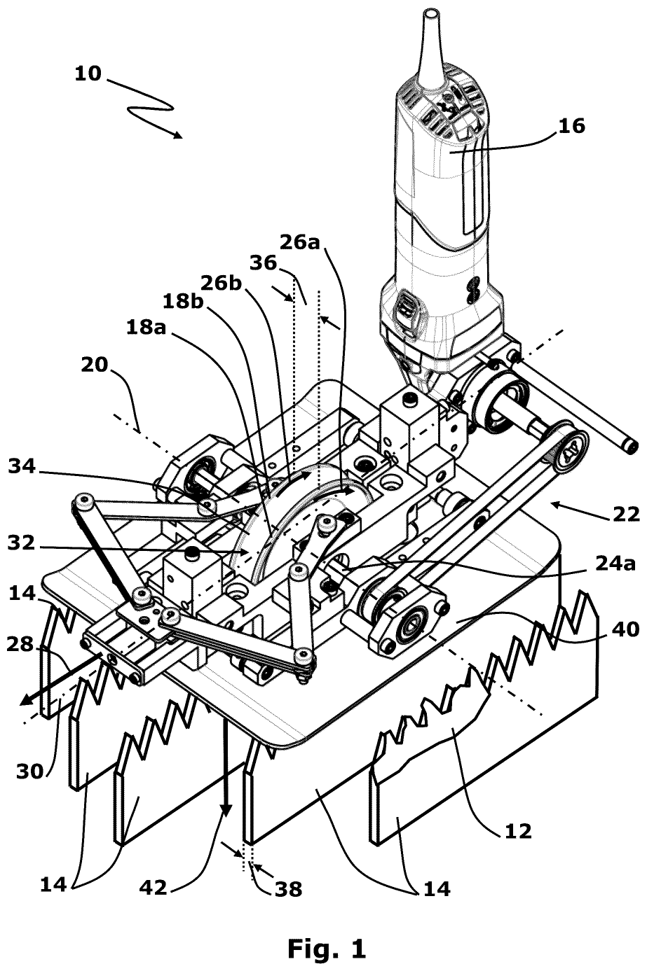

FIG. 1 shows a cleaning device 10 for removing impurities 12 from a bar-shaped structure 14 in a state arranged on the bar-shaped structure 14. The cleaning device 10 can, for example, be attached to a support bar (not shown) of a pallet (not shown) for a laser cutting machine (not shown) in order to remove impurities 12, typically metal slag, which adheres to the support bar during the manufacturing of workpieces (not shown) in the laser cutting machine.

According to the embodiment shown, the cleaning device 10 has a single drive unit 16. In addition, the cleaning device 10 has two roughing discs 18a, 18b. The roughing discs 18a, 18b can be designed to be predominantly rotationally symmetrical. The roughing discs 18a, 18b are designed to rotate about a common axis of rotation 20. According to the embodiment shown, the roughing discs 18a, 18b can also be driven by the individual drive unit 16. To drive the roughing discs 18a, 18b, the cleaning device 10 has a belt drive 22 which connects the drive unit 16 with a drive shaft 24a of the roughing disc 18a. The drive shaft 24a can be designed to drive both roughing discs 18a, 18b. Furthermore, as shown, it can be provided that the roughing disc 18a is arranged on and/or at the drive shaft 24a and the roughing disc 18b can be arranged and/or formed on its own separate drive shaft 24b. In this case, torque can be transmitted from the drive shaft 24a to the drive shaft 24b, for example, by a torque-transmitting connection, for example an axial pinning of the drive shafts 24a, 24b.

The roughing discs 18a, 18b can have the same direction of rotation 26a, 26b during operation of the cleaning device 10. This allows a simple and cost-effective production of the cleaning device 10. The directions of rotation 26a, 26b are preferably adapted to a feed direction 28 along a feed axis 30. Preferably, the roughing discs 18a, 18b emerge from the bar-shaped structure 14 on the side of the roughing discs 18a, 18b that is located upstream in the feed direction 28 and enter the bar-shaped structure 14 on the side of the roughing discs 18a, 18b that is located downstream in the feed direction 28. This corresponds to the arrow directions of the rotational directions 26a, 26b shown in FIG. 1. In other words, impurities 12 are scrubbed from the bar-shaped structure 14 in the direction of the cleaning device 10. This allows the removal of impurities 12 to be carried out more effectively.

Alternatively or additionally, it can be provided that each drive shaft 24a, 24b can be driven by its own belt drive 22. A torque transmission between the drive shafts 24a, 24b can thus be eliminated.

In a preferred embodiment, the direction of rotation 26a can be opposite to the direction of rotation 26b. As a result, the forces and torques caused by the roughing discs 18a, 18b can be compensated during operation of the cleaning device 10, so that handling of the cleaning device 10 can be simplified.

Alternatively or additionally, it can be provided that each drive shaft 24a, 24b can be driven by its own drive unit 16. In other words, the cleaning device 10 in this embodiment has at least two drive units 16. This can increase the performance of the cleaning device 10.

The roughing discs 18a, 18b form a receiving region 32 along the axis of rotation 20 for the bar-shaped structure 14, which approximately corresponds to the distance between the roughing discs 18a, 18b. In other words, the bar-shaped structure 14 can be arranged at least in sections between the two roughing discs 18a, 18b. As a result, the impurities 12 can be effectively removed in one cleaning procedure on both sides of the bar-shaped structure 14. The receiving region 32 can be formed, for example, by a structural design of the roughing discs 18a, 18b and/or by spacing the roughing discs 18a, 18b apart along the common axis of rotation 20.

Each of the roughing discs 18a, 18b has, on a side facing the receiving region 32, a plurality of roughing projections 34. In other words, the roughing projections 34 protrude beyond the respective roughing disc 18a, 18b into the receiving region 32. According to FIG. 1, the roughing projections 34 are in the form of a surface roughness formed on the respective roughing disc 18a, 18b. For example, the surface roughness can be formed by diamond segments introduced into the roughing discs 18a, 18b.

According to embodiments of the invention, the roughing discs 18a, 18b are formed along the axis of rotation 20 in a movably sprung manner. The receiving region 32, in a state not arranged on the bar-shaped structure 14, typically has a predominantly smaller receiving region width 36 along the axis of rotation 20 than a bar width 38 of the bar-shaped structure 14. When the cleaning device 10 is arranged on the bar-shaped structure 14, the bar-shaped structure 14 displaces the roughing discs 18a, 18b against a restoring force, typically against a spring force. This allows the roughing discs 18a, 18b to be pushed onto both sides of the bar-shaped structure 14, thereby ensuring permanent contact between the roughing discs 18a, 18b during the removal of the impurities 12. In other words, the roughing discs 18a, 18b can be displaced along the axis of rotation 20 in the direction of the bar-shaped structure 14 when the bar width 38 of the bar-shaped structure 14 is reduced during cleaning. This is the case, for example, when the impurity 12 is removed from the bar-shaped structure 14. A further advantage of the roughing discs 18a, 18b formed in a movably sprung manner is that the receiving region 32 can be flexibly adapted to different bar widths 38 of bar-shaped structures 14 to be cleaned. An otherwise necessary retrofit of the cleaning device 10 can thus be omitted.

The cleaning device 10 can be moved along the feed axis 30 on the bar-shaped structure 14 to remove the impurities 12. The cleaning device 10 can be moved several times along the feed axis 30 in order to remove the impurities 12 particularly effectively. Preferably, the cleaning device 10 can be moved forward and/or backward along the feed axis 30. This eliminates the need to lift and turn the cleaning device 10. It can be provided that the direction of rotation 26a and/or the direction of rotation 26b is changed when the feed direction 28 changes.

According to the embodiment shown in FIG. 1, the cleaning device 10 can have a structural stop 40. The structural stop 40 can be designed to place the cleaning device 10 on one or a plurality of bar-shaped structures 14. The structural stop 40 can limit the penetration depth 42 of the cleaning device 10 into the bar-shaped structure 14. The penetration depth 42 is preferably perpendicular to the feed axis 30 and/or perpendicular to the axis of rotation 20. This allows the impurities 12 to be removed particularly evenly and effectively.

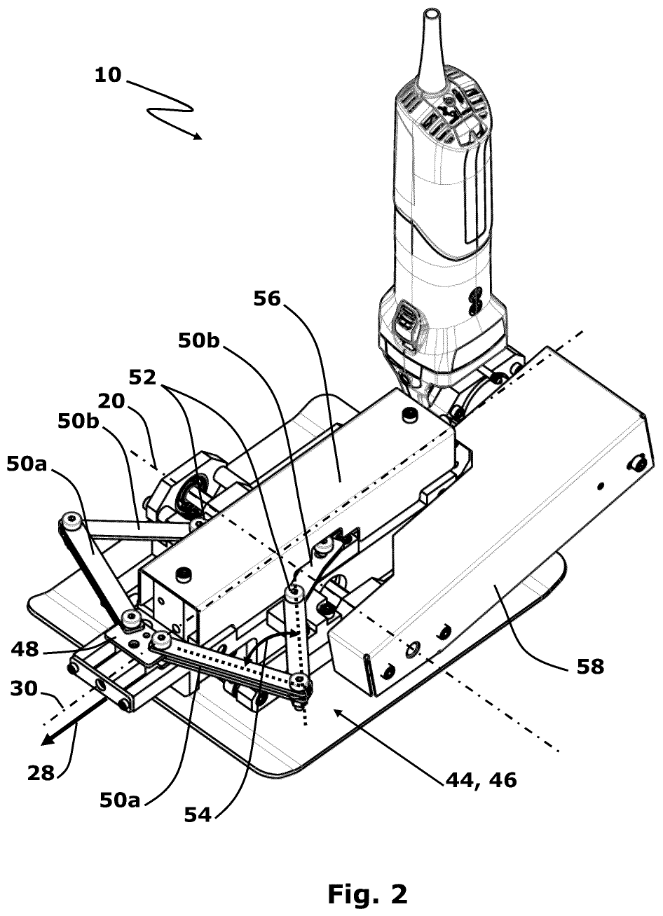

FIG. 2 shows the cleaning device 10 from FIG. 1.

The cleaning device 10 can, as shown, have a spreading mechanism 44. By means of the spreading mechanism 44, the distance between the roughing discs 18a, 18b (see FIG. 1) can be increased. This enables a particularly low-resistance arrangement on and/or removal from the bar-shaped structure 14 (see FIG. 1). Furthermore, the cleaning device 10 can be more easily removed from the bar-shaped structure 14 by means of the spreading mechanism 44, for example if the latter becomes jammed during cleaning. This can prevent disassembly that would otherwise be necessary.

The spreading mechanism 44 can, for example, be designed as a lever system 46. The lever system 46 can, as shown, have a spreading plate 48, two first spreading levers 50a and two second spreading levers 50b. Preferably, the spreading mechanism 44 or the lever system 46 is designed symmetrically to the feed axis 30. The spreading plate 48 is arranged on the cleaning device 10 so as to be movable along the feed axis 30. In each case, a first spreading lever 50a can be rotatably arranged at one end on the spreading plate 48 and at the other end on the second spreading lever 50b. In each case, a second spreading lever 50b can be rotatably arranged directly or indirectly on a roughing disc 18a, 18b at an end facing away from the end arranged on the first spreading lever 50a. In each case, a second spreading lever 50b can be rotatably mounted on the cleaning device 10 by means of a bearing point 52, wherein a rotatable bearing point 52 is formed in each case between the end arranged on the first spreading lever 50a and the end arranged on the roughing disc 18a, 18b.

By moving the spreading plate 48 along the feed axis 30—here in the feed direction 28—the roughing discs 18a, 18b can be spread. A spreading angle 54 between one of the first spreading levers 50a and the respective second spreading lever 50b can be changed, whereby the ends of the second spreading levers 50b arranged on the roughing discs 18a, 18b are spaced further apart along the axis of rotation 20 or moved in opposite directions.

The cleaning device 10 can have a protective cover 56 as shown to cover the roughing discs 18a, 18b and/or a protective cover 58 to cover the belt drive 22 (see FIG. 1). In this way, unintentional intervention in the rotating roughing discs 18a, 18b and/or in the belt drive 22 during operation of the cleaning device 10 can be effectively prevented. In addition, by covering the roughing discs 18a, 18b, the surroundings can be protected from the detached and possibly flung impurity 12 (see FIG. 1).

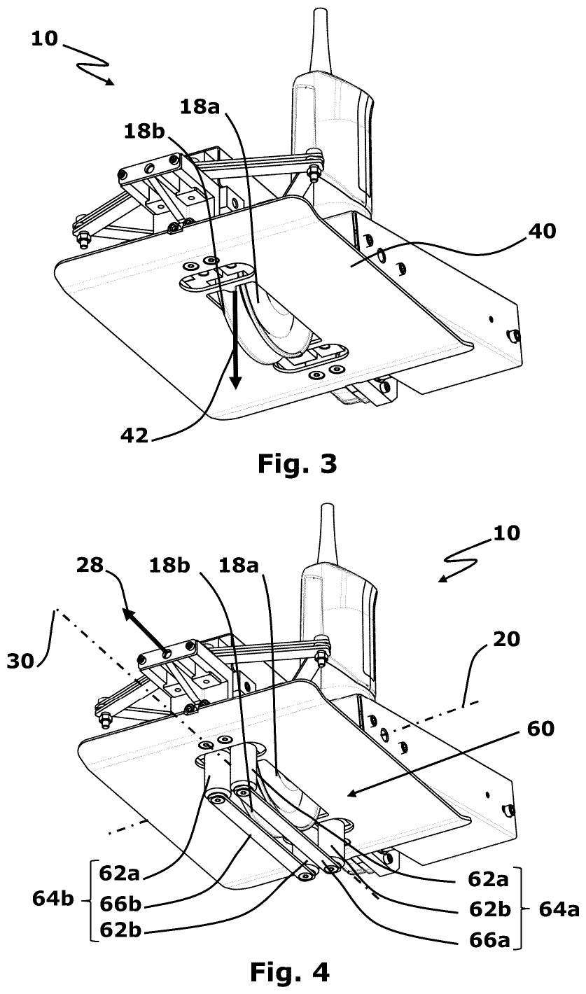

FIG. 3 shows the cleaning device 10 from FIG. 2 in a perspective view looking towards the side of the cleaning device 10 facing the bar-shaped structure 14 (see FIG. 1) during operation of the cleaning device 10.

The roughing discs 18a, 18b can protrude in the penetration direction. The penetration depth 42 of the cleaning device 10 can be determined by the projection of the roughing discs 18a, 18b. According to the embodiment shown, the penetration depth 42 of the roughing discs 18a, 18b is limited by the structural stop 40. In other words, during operation of the cleaning device 10, the structural stop 40 can rest against the bar-shaped structure 14 and/or an adjacent bar-shaped structure 14, thereby preventing the roughing discs 18a, 18b from penetrating further into the bar-shaped structure 14. The penetration depth 42 can be adjustable by moving the structural stop 40.

FIG. 4 shows a further embodiment of the cleaning device 10.

The cleaning device 10 has a bar guide 60. The bar guide 60 is preferably designed to be parallel to the longitudinal axis of the roughing discs 18a, 18b. The bar guide 60 can be designed to rest on the bar-shaped structure 14 to be cleaned (see FIG. 1). This makes it particularly easy to move the cleaning device 10 along the feed axis 30 of the cleaning device 10 parallel to the bar-shaped structure 14.

According to the embodiment shown, the bar guide 60 can have a plurality of—here four—guide rollers 62a, 62b. As can be seen in FIG. 4, the guide rollers 62a, 62b of the bar guide 60 run parallel to the longitudinal axis of the roughing discs 18a, 18b, in FIG. 4 perpendicular to the feed axis 30. The guide rollers 62a, 62b are preferably arranged at right angles to the feed axis 30 and/or the axis of rotation 20 on the cleaning device 10. The guide rollers 62a, 62b are preferably rotatably mounted on the cleaning device 10 and/or have a contact surface which is rotatable relative to the cleaning device 10 and which, during operation of the cleaning device 10, is in contact with the bar-shaped structure 14 to be cleaned. This allows the cleaning device 10 to be guided with particularly low friction.

The guide rollers 62a and the guide rollers 62b can be arranged along the feed axis 30 on opposite sides of the roughing discs 18a, 18b. In other words, the guide rollers 62a or the guide rollers 62b can be arranged upstream of the roughing discs 18a, 18b depending on the feed direction 28 along the feed axis 30 and the respective other guide rollers 62b, 62a can be arranged downstream of the roughing discs 18a, 18b. According to the feed direction 28 shown in FIG. 4, the guide rollers 62a are thus arranged upstream and the guide rollers 62b are arranged downstream.

The guide rollers 62a and the guide rollers 62b are typically spaced apart from one another and each form a guide region for receiving the bar-shaped structure 14. Preferably, the guide rollers 62a, 62b are each formed in a transverse direction to the feed axis 30, in particular along the axis of rotation 20, in a movably sprung manner. This allows the bar guide 60 to be adapted to the bar width 38 (see FIG. 1). In particular, the guide rollers 62a, 62b arranged downstream of the roughing discs 18a, 18b in the forward direction or feed direction 28 can have a smaller distance than the upstream guide rollers 62a, 62b, since the bar width 38 can be reduced as a result of the cleaning.

Each guide roller 62a and guide roller 62b can form a guide roller pair 64a, 64b. The guide rollers 62a, 62b of a guide roller pair 64a, 64b can be connected by a guide plate 66a, 66b. As a result, the guide rollers 62a, 62b of a guide roller pair 64a, 64b can be moved particularly evenly.

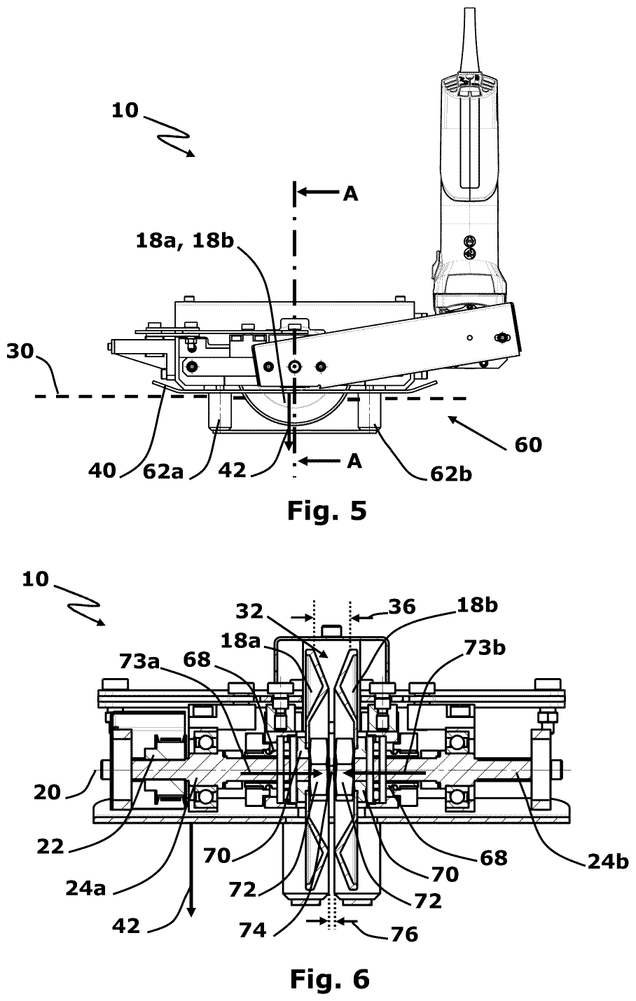

FIG. 5 shows the cleaning device 10 from FIG. 4 in a side view. According to the embodiment shown, the guide rollers 62a, 62b protrude further beyond the structural stop 40 in the direction of the penetration depth 42 than the roughing discs 18a, 18b. In this way, contact between the peripheral sides of the roughing discs 18a, 18b and the bar-shaped structure 14 (sec FIG. 1) and/or a carrier (not shown) of the bar-shaped structure 14 can be prevented.

During operation of the cleaning device 10, the cleaning device 10 can be moved bidirectionally along the feed axis 30. In other words, the cleaning device 10 can be moved from left to right and/or from right to left as shown. In the latter case, the bar-shaped structure 14 is first guided over the upstream guide rollers 62a into the receiving region 32 (see FIG. 1) between the roughing discs 18a, 18b. The cleaning device 10 is moved further over the bar-shaped structure 14, whereby an impurity 12 (see FIG. 1) is removed by the roughing discs 18a, 18b. The bar-shaped structure 14 is then guided over the downstream guide rollers 62b.

FIG. 6 shows the cleaning device 10 from FIG. 5 rotated by 90o according to the section A-A shown in FIG. 5.

The roughing discs 18a, 18b are arranged in a rotationally fixed manner on the drive shafts 24a, 24b. In other words, the roughing discs 18a, 18b can be driven to rotate by the drive shafts 24a, 24b and can also be moved along the axis of rotation 20 up to a stop. According to the embodiment shown, a sliding sleeve 68 can be provided on each drive shaft 24a, 24b, which sliding sleeve can be arranged slidably along the axis of rotation 20 on the respective drive shaft 24a, 24b. The sliding sleeve 68 preferably has a flange region 70, on which the respective roughing disc 18a, 18b can be placed. To fix the roughing discs 18a, 18b, it can be provided that a nut 72 is screwed onto the end of the sliding sleeve 68 having the flange region 70. The sliding sleeves 68, together with the roughing discs 18a, 18b arranged thereon, are formed along the axis of rotation 20 in a movably sprung manner. If a sliding sleeve 68 is deflected together with a roughing disc 18a, 18b, a restoring spring force 73a, 73b is applied in the direction of the other roughing disc 18a, 18b. This ensures that both roughing discs 18a, 18b are pressed against a structure 14 to be cleaned.

In the embodiment shown, the drive shaft 24a is driven directly by the belt drive 22, while the drive shaft 24b is arranged in a torque-transmitting manner on the drive shaft 24a by means of a pin connection in the form of two bolts 74. In the view shown in FIG. 6, only one bolt 74 is visible.

The roughing discs 18a, 18b form the receiving region 32. The receiving region 32 can have the receiving region width 36. The receiving region width 36 can be formed as shown at the radially outer end of the roughing discs 18a, 18b. The receiving region 32 can have a roughing width 76. The receiving region 32 has the roughing width 76 preferably spaced in the radial direction from the outer edge of the roughing discs 18a, 18b. Preferably, the receiving region 32 is tapered in the radially inward direction of the roughing discs 18a, 18b. In other words, the roughing width 76 of the receiving region 32 is typically smaller than the receiving region width 36. The receiving region 32 can form an entry angle. As a result, the cleaning device 10 can be arranged particularly easily with little resistance due to the bar-shaped structure 14 (see FIG. 1). Furthermore, the impurity 12 can be progressively removed with increasing penetration depth 42, whereby the effort required for cleaning can be reduced and the handling of the cleaning device 10 can be made easier.

Furthermore, the receiving region 32 may have a widening portion adjacent to the tapered portion. In this case, the section of the receiving region 32 having the roughing width 76 can represent the smallest spacing between the roughing discs 18a, 18b. With increasing penetration depth 42, an already cleaned section of the bar-shaped structure 14 can be introduced into the widening section of the receiving region 32 without further contact with the roughing discs 18a, 18b. Further material removal can thus be effectively prevented.

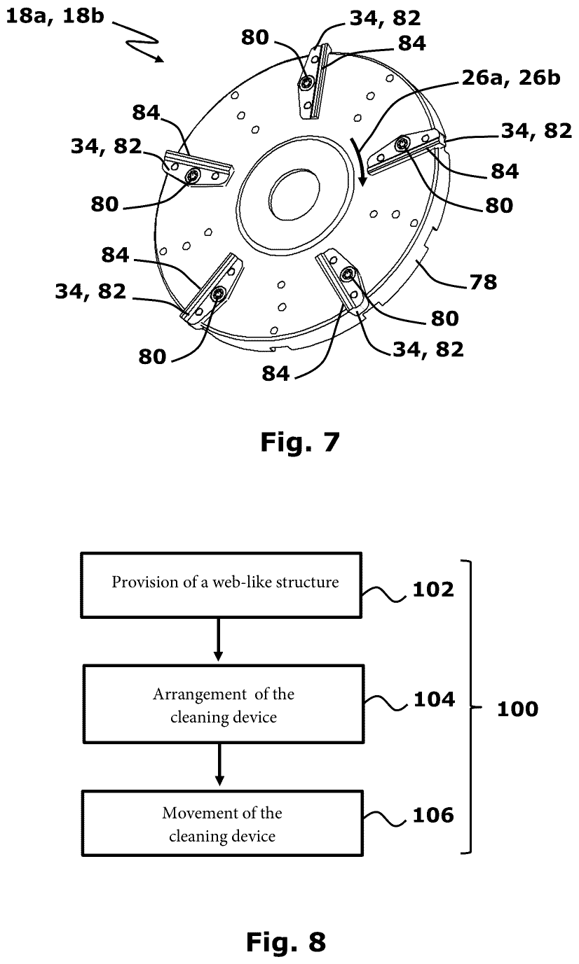

FIG. 7 shows an alternative embodiment of a roughing disc 18a, 18b.

The depicted roughing disc 18a, 18b has five roughing projections 34 which are arranged on a roughing disc base body 78—here each screwed on by means of a fastening screw 80. The roughing projections 34 are designed as blade rails 82 according to the embodiment shown. The blade rails 82 can each have a blade 84 which are arranged in a direction of rotation 26a, 26b. Preferably, the blade rails 82 have more than one blade 84, but at least two blades 84. The at least two blades 84 are preferably arranged in a different direction of rotation on the roughing disc 18a, 18b.

FIG. 8 shows a schematic representation of a cleaning method 100 according to embodiments of the invention.

In a method step 102, the bar-shaped structure 14 (see FIG. 1) can first be provided.

In a subsequent method step 104, the cleaning device 10 (see FIG. 1) is arranged on the bar-shaped structure 14. In other words, the cleaning device 10 is placed on the bar-shaped structure 14 in such a way that the bar-shaped structure 14 is arranged or positioned at least in sections within the receiving region 32 (see FIG. 1) or between the roughing discs 18a, 18b of the cleaning device 10.

In a further method step 106, the cleaning device 10 will be moved along the bar-shaped structure 14. The cleaning device 10 can be moved in the feed direction 28 (see FIG. 1) along the feed axis 30 (see FIG. 1).

The cleaning device 10 can be moved forward or backward on the bar-shaped structure 14. It can be provided that the direction of rotation 26a, 26b (see FIG. 1) of the roughing discs 18a, 18b is changed.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Symbols

Cleaning device 10;
Impurity 12;
Bar-shaped structure 14;
Drive unit 16;
Roughing disc 18a, 18b;
Axis of rotation 20;
Belt drive 22;
Drive shaft 24a, 24b;
Direction of rotation 26a, 26b;
Feed axis 30;
Feed direction 28;
Receiving region 32;
Roughing projections 34;
Receiving region width 36;
Bar width 38 of the bar-shaped structure 14;
Structural stop 40;
Penetration depth 42;
Spreading mechanism 44;
Lever system 46;
Spreading plate 48;
First spreading lever 50a;
Second spreading lever 50b;
Bearing point 52;
Spreading angle 54;
Protective cover 56, 58;
Bar guide 60;
Guide rollers 62a, 62b;
Guide roller pair 64a, 64b;
Guide plate 66a, 66b;
Sliding sleeve 68;
Flange region 70;
Nut 72;
Spring force 73a, 73b
Bolt 74;
Roughing width 76;
Roughing disc base body 78;
Fastening screw 80;
Blade rail 82;
Blade 84;
Cleaning method 100;
Method step 102, 104, 106
Section A-A.

1. A cleaning device for removing impurities from a bar-shaped structure, the cleaning device comprising:
a drive unit; and
two roughing discs capable of being driven to rotate about a common axis of rotation;
wherein at least one roughing disc of the two roughing discs is capable of being driven by the drive unit;
wherein the two roughing discs form, along the common axis of rotation, a receiving region for the bar-shaped structure;
wherein each roughing disc has, on a side facing the receiving region, a plurality of roughing projections; and
wherein the two roughing discs are formed along the axis of rotation in a movably sprung manner in order to cause, in a state in which the two roughing discs are arranged on the bar-shaped structure, the roughing discs to be pushed onto both sides of the bar-shaped structure.

2. The cleaning device according to claim 1, wherein the two roughing discs are arranged parallel to each other.

3. The cleaning device according to claim 1, wherein the receiving region formed by the two roughing discs comprises a tapering receiving region in a radially inwardly directed direction, and a widening receiving region following the tapering receiving region.

4. The cleaning device according to claim 1, wherein the roughing projections of at least one roughing disc are configured as a surface grain formed on the at least one roughing disc, or as blade rails arranged on the at least one roughing disc.

5. The cleaning device according to claim 1, further comprising a structural stop for limiting a penetration depth in a penetration direction of the two roughing discs into the bar-shaped structure.

6. The cleaning device according to claim 1, wherein at least one of the two roughing discs is driven by at least one belt drive.

7. The cleaning device according to claim 1, wherein each roughing disc of the two roughing discs is arranged on a respective drive shaft.

8. The cleaning device according to claim 1, wherein the two roughing discs have contrary directions of rotation.

9. The cleaning device according to claim 7, further comprising a second drive unit, wherein a first roughing disc of the two roughing discs is driven by the drive unit, and a second roughing disc of the two roughing discs is driven by the second drive unit.

10. The cleaning device according to claim 1, further comprising a spreading mechanism, wherein the spreading mechanism is configured to widen the receiving region.

11. The cleaning device according to claim 10, wherein the spreading mechanism is configured as a lever system.

12. The cleaning device according to claim 1, further comprising a bar guide, wherein the bar guide causes a guidance of the cleaning device parallel to the two roughing discs in a feed direction of the cleaning device.

13. The cleaning device according to claim 12, wherein the bar guide comprises four guide rollers, wherein the four guide rollers are arranged at right angles to the feed direction and the axis of rotation, wherein two of the four guide rollers are arranged upstream of the roughing discs in the feed direction, and other two of the four guide rollers are arranged downstream of the roughing discs in the feed direction, and wherein the four guide rollers protrude beyond the two roughing discs in a penetration direction.

14. The cleaning device according to claim 13, further comprising two guide plates arranged in parallel, wherein a respective upstream guide roller and a respective downstream guide roller are connected by a respective guide plate.

15. A cleaning method for removing impurities from a bar-shaped structure, using a cleaning device according to claim 1, the cleaning method comprising:
arranging the bar-shaped structure between the two roughing discs; and
moving the cleaning device along the bar-shaped structure.
